(19) United States
(12) Patent Application Publication
(10) Pub. No.: US 2011/0116025 A1
(43) Pub. Date: May 19, 2011

(54) OPTICAL FILTER FOR DISPLAY DEVICE AND DISPLAY DEVICE HAVING THE SAME

(75) Inventors: Seong Sik Park, ChungCheongNam-Do (KR); Seung Won Park, ChungCheongNam-Do (KR); In Sung Sohn, ChungCheongNam-Do (KR); Eun Young Cho, ChungCheongNam-Do (KR)

(73) Assignee: SAMSUNG CORNING PRECISION MATERIALS CO., LTD., Gyeongsangbuk-do (KR)

(21) Appl. No.: 12/904,420

(22) Filed: Oct. 14, 2010

(30) Foreign Application Priority Data
Oct. 15, 2009 (KR) 10-2009-0098035

(51) Int. Cl. G02F 1/1335

(52) U.S. Cl. 349/106

(57) ABSTRACT

An optical filter provided in front of a display panel of a display device includes a background layer and a color shift-reducing pattern formed to a predetermined thickness at the background layer. The color shift-reducing pattern has a plurality of partial areas, and at least two partial areas of the plurality of partial areas have different light absorptivities and/or light diffusivities. The at least two partial areas may contain different amounts of a light-absorbing material that cause the different light-absorptivities and/or different amounts of a light-diffusing material that cause the different light diffusivities. The color shift-reducing pattern may have first and second partial areas, in which only the first partial area may contain the light-absorbing material, and only the second partial area may contain the light-diffusing material. The light-absorbing material may include a green wavelength-absorbing material that absorbs light having green wavelengths from 510 nm to 560 nm. The light-diffusing material may include light-diffusing beads.

### CROSS REFERENCE TO RELATED APPLICATION

The present application claims priority from Korean Patent Application Number 10-2009-0098035 filed on Oct. 15, 2009, the entire contents of which application are incorporated herein for all purposes by this reference.

### BACKGROUND OF THE INVENTION

1. Field of the Invention

The present invention relates to an optical filter for a display device and a display device having the same, and more particularly, to an optical filter for a display device having a color shift-reducing pattern and a display device having the same.

2. Description of Related Art

In response to the emergence of the advanced information society, components and devices related to photoelectronics have been significantly improved and rapidly disseminated. Among them, image display devices have been widely distributed for use in TVs, Personal Computer (PC) monitors, and the like. Moreover, attempts are underway to simultaneously increase the size and reduce the thickness of such display devices.

In general, a Liquid Crystal Display (LCD) is one type of flat panel display, and displays images using liquid crystals. The LCD is widely used throughout the industry since it has the advantages of light weight, low drive voltage, and low power consumption compared to other display devices.

FIG. 1 is a conceptual view schematically showing the basic structure and operating principle of an LCD 100.

With reference by way of example to a conventional Vertical Alignment (VA) LCD, two polarizer films 110 and 120 are arranged such that their optical axes are oriented perpendicular to each other. Liquid crystal molecules 150 having birefringence characteristics are injected and arranged between two transparent substrates 130, which are coated with transparent electrodes 140. When an electric field is applied from a power supply unit 180, the liquid crystal molecules move and are aligned perpendicular to the electric field.

Light emitted from a backlight unit is linearly polarized after passing through the first polarizer film 120.

As shown in the left of FIG. 1, liquid crystal remains perpendicular to the substrates when no power is applied. The liquid crystal, in this state, does not change the polarization of the light. As a result, the light, which is in a linearly-polarized state, is blocked by the second polarizer film 110, the optical axis of which is perpendicular to that of the first polarizer film 120.

In the meantime, as shown in the right of FIG. 1, when power is on, the electric field causes the liquid crystal to shift to a horizontal alignment parallel to the substrates, between the two orthogonal polarizer films 110 and 120. Thus, the linearly-polarized light from the first polarizer film is converted into another kind of linearly-polarized light, the polarization of which is rotated by 90°, circularly-polarized light, or elliptically polarized light while passing through the liquid crystal molecules before it reaches the second polarizer film. The converted light is then able to pass through the second polarizer film. It is possible to gradually change the orientation of the liquid crystal from the vertical position to the horizontal position by adjusting the intensity of the electric field, thereby allowing control of the intensity of light emission.

FIG. 2 is a conceptual view showing the orientation and optical transmittance of liquid crystal depending on the watching angle.

When liquid crystal molecules are aligned in a predetermined direction in a pixel 220, the orientation of the liquid crystal molecules looks different depending on the watching angle.

When viewed from the front left along the line 210, the liquid crystal molecules look as if they are substantially aligned along the horizontal orientation 212, and the image looks relatively brighter. When viewed from the front along the line 230, the liquid crystal molecules are seen to be aligned along the orientation 232, which is the same as the actual orientation of the liquid crystal molecules inside the pixel 220. In addition, when viewed from the front left along the line 250, the liquid crystal molecules look as if they are substantially aligned along the vertical orientation 252, and the image looks somewhat darker.

Accordingly, the viewing angle of the LCD is greatly limited compared to other displays that spontaneously emit light, since the intensity and color of light of the LCD varies depending on the watching angle. In order to increase the viewing angle, a large amount of research has been carried out.

FIG. 3 is a conceptual view showing a conventional attempt to reduce variation in the contrast ratio and color shift depending on the watching angle.

Referring to FIG. 3, a pixel is divided into two pixel parts, that is, first and second pixel parts 320 and 340, in which the orientations of liquid crystal are symmetrical to each other. Both the liquid crystals oriented as shown in the first pixel part 320 and the liquid crystals oriented as shown in the second pixel part 340 can be seen. The intensity of light reaching the user is the total intensity of light of the two pixel parts.

When viewed from the front left along the line 310, liquid crystal molecules in the first pixel part 320 look as if they are aligned along the horizontal orientation 312, and liquid crystal molecules in the second pixel part 320 look as if they are aligned along the vertical orientation 314. Thus, the first pixel part 320 makes the image look bright. Likewise, when viewed from the front right along the line 350, the liquid crystal molecules in the first pixel part 320 look as if they are aligned along the vertical orientation 352, and the liquid crystal molecules in the second pixel part 340 look as if they are aligned along the horizontal orientation 354. Then, the second pixel part 340 can make the image look bright. In addition, when viewed from the front, the liquid crystal molecules are seen to be aligned along the orientations 332 and 334, which are the same as the actual orientations of the liquid crystal molecules inside the pixel parts 320 and 340. Accordingly, the brightness of the image observed by the user remains uniform and is symmetrical about the vertical center line of the screen, even when the watching angle changes. This, as a result, makes it possible to reduce variation in the contrast ratio and color shift depending on the watching angle.

FIG. 4 is a conceptual view showing another conventional approach for reducing variation in contrast ratio and color shift depending on the watching angle.

Referring to FIG. 4, an optical film 420 having birefringence characteristics is added. The birefringence characteristics of the optical film 420 are the same as those of liquid crystal molecules inside a pixel 440 of an LCD panel, and the orientation thereof are symmetrical with the orientation of the liquid crystal molecules. Due to the orientation of the liquid crystal molecules inside the pixel 440 and the birefringence characteristics of the optical film, the intensity of light reaching the user is the total intensity of light passing through the pixel 440 and the optical film 420.

Specifically, when viewed from the front left along the line 410, the liquid crystal molecules inside the pixel 440 look as if they are aligned along the horizontal orientation 414 and imaginary liquid crystals produced by the optical film 420 look as if they are aligned along the vertical orientation 412. The resultant intensity of light is the total intensity of light passing through the pixel 440 and the optical film 420. Likewise, when viewed from the front right along the line 450, the liquid crystal molecules inside the pixel 440 look as if they are aligned along the vertical orientation 454 and the imaginary liquid crystals produced by the optical film 420 look as if they are aligned along the horizontal orientation 452. The resultant intensity of light is the total intensity of light passing through the pixel 440 and the optical film 420. In addition, when viewed from the front, the liquid crystal molecules are seen to be aligned along the orientations 434 and 432, which are the same as the actual orientation of the liquid crystal molecules inside the pixel 440 and the orientation of the optical film 420, respectively.

However, even if the approaches shown in FIGS. 3 and 4 are applied, there still exists the problem as shown in FIG. 5. That is, a color shift still occurs depending on the watching angle, and the color changes as the watching angle increases.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide an optical filter for a display device that can mitigate color shift according to an increase in a watching angle and a display device having the same.

Technical features of the invention are not limited to the foregoing technical object, and other technical objects, which have not been mentioned above, will be more fully apparent to a person having ordinary skill in the art from the following description.

In an aspect of the present invention, the optical filter provided in front of a display panel of a display device includes a background layer and a color shift-reducing pattern formed to a predetermined thickness at the background layer. The color shift-reducing pattern has a plurality of partial areas, and at least two partial areas of the plurality of partial areas have different light absorptivities and/or light diffusivities.

The at least two partial areas can contain different amounts of a light-absorbing material that cause the different light-absorptivities and/or different amounts of a light-diffusing material that cause the different light diffusivities.

The color shift-reducing pattern may have first and second partial areas, in which only the first partial area may contain the light-absorbing material, and only the second partial area may contain the light-diffusing material.

The light-absorbing material may include a green wavelength-absorbing material that absorbs light having green wavelengths from 510 nm to 560 nm.

The light-diffusing material may include light-diffusing beads.

As set forth above, the embodiments of the invention minimize color shift according to an increase in a watching angle, thereby ensuring that a display device has a wide viewing angle and improved image quality.

### BRIEF DESCRIPTION OF THE DRAWINGS

FIG. 1 is a conceptual view schematically showing the basic structure and operating principle of an LCD;

FIG. 2 is a conceptual view showing the orientation and optical transmittance of liquid crystals depending on the watching angle;

FIG. 3 is a conceptual view showing a conventional attempt to reduce variation in the contrast ratio and color shift depending on the watching angle;

FIG. 4 is a conceptual view showing another conventional attempt to reduce variation in the contrast ratio and color shift depending on the watching angle;

FIG. 5 is a graph showing color shifts depending on watching angles in an LCD on which an optical filter of the invention is not mounted;

FIG. 6 is a perspective view showing an optical filter according to a comparative embodiment of the invention;

FIGS. 7 and 8 are reference views for explaining light-absorbing materials;

FIG. 9 is a graph showing color shifts in an LCD on which the optical filter shown in FIG. 6 is mounted;

FIG. 10 is a cross-sectional view showing an optical filter according to a first exemplary embodiment of the invention;

FIGS. 11 and 12 are reference views for explaining cyan wavelength-absorbing materials and orange wavelength-absorbing materials;

FIGS. 13 and 14 are reference views for explaining black materials;

FIG. 15 is a flow diagram showing a process of fabricating the optical filter shown in FIG. 10;

FIG. 16 is a graph showing color shifts in an LCD on which the optical filter shown in FIG. 10 is mounted;

FIG. 17 is a cross-sectional view showing an optical filter according to a second exemplary embodiment of the invention; and

FIG. 18 is a cross-sectional view showing an optical filter according to a third exemplary embodiment of the invention.

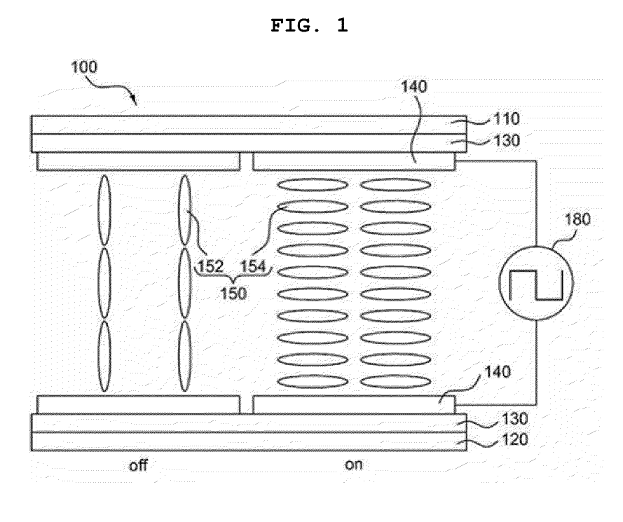

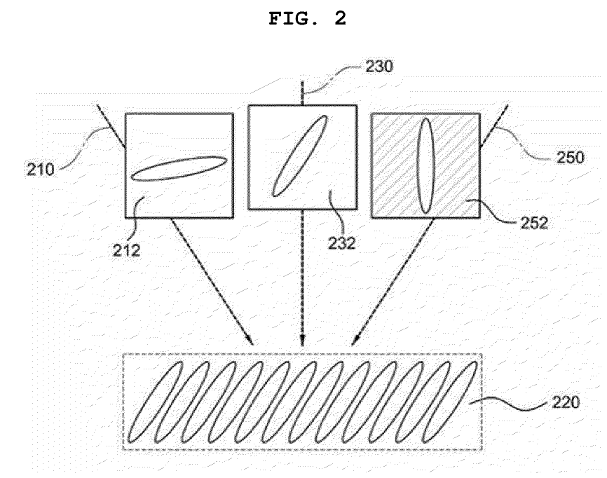

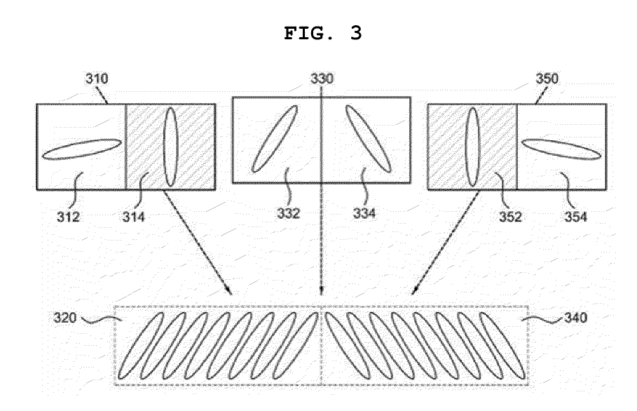

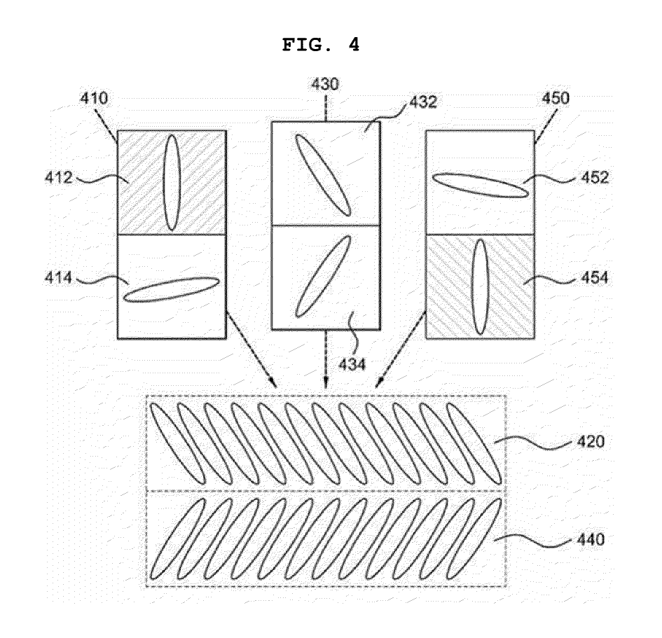

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

### Comparative Embodiment

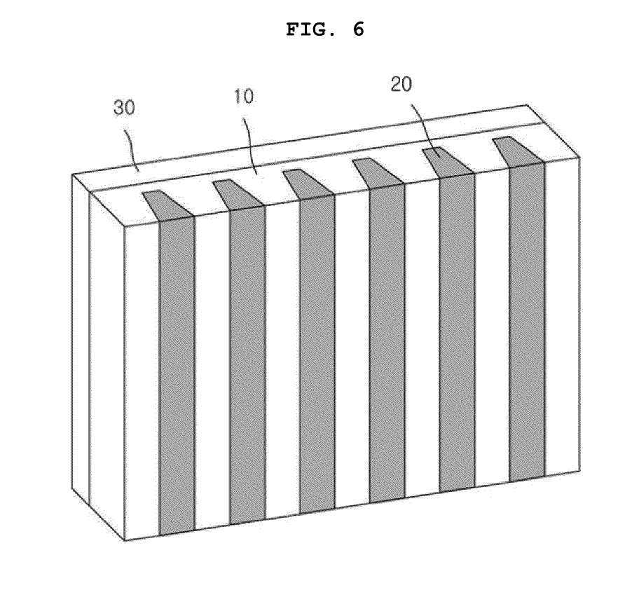

FIG. 6 is a perspective view showing an optical filter according to a comparative embodiment of the invention.

As shown in the figure, the optical filter of FIG. 6 includes a background layer 10 and a color shift-reducing pattern 20.

The color shift-reducing pattern 20 contains a light-absorbing material. The light-absorbing material includes a green wavelength-absorbing material that absorbs light having green wavelengths in the range from 510 nm to 560 nm. The light-absorbing material may also include a cyan wavelength-absorbing material that absorbs light having cyan wavelengths in the range from 480 nm to 510 nm and an orange wavelength-absorbing material that absorbs light having orange wavelengths in the range from 570 nm to 600 nm. In addition, the light-absorbing material may also include a black material, such as carbon black.

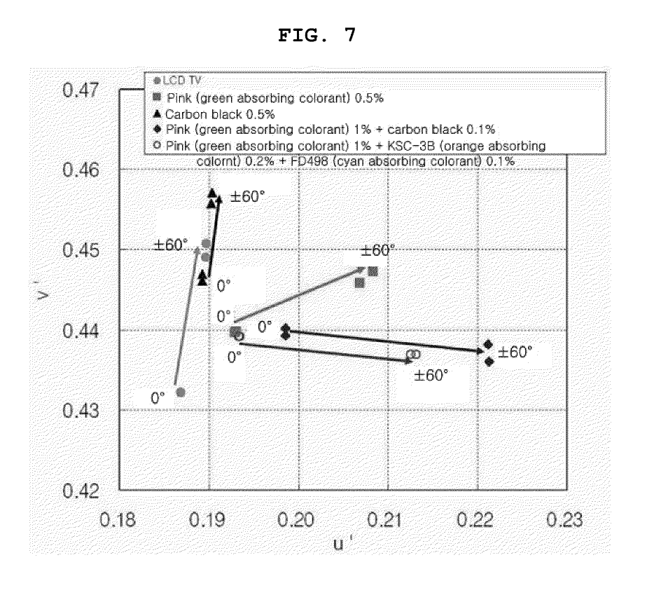

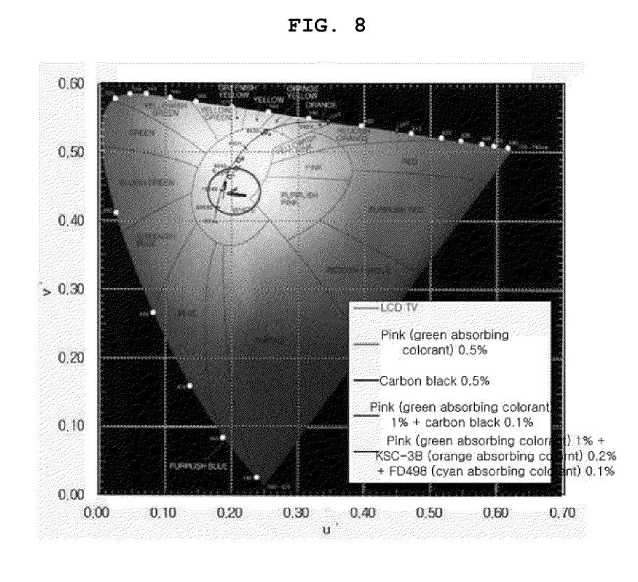

FIGS. 7 and 8 are reference views for explaining light-absorbing materials.

Various optical filters having the color shift-reducing pattern 20 that contain a green wavelength-absorbing material, a cyan wavelength-absorbing material, an orange wavelength-absorbing material, carbon black, or the like, were mounted on an LCD TV, and then color coordinates of a full white screen when viewing it from the front and at a watching angle of 60° were compared.

When the green wavelength-absorbing material is contained in the color shift-reducing pattern 20 having a wedge-shaped cross section, the color of the green wavelength-absorbing material is exhibited stronger according to an increase in the watching angle, so that color coordinates shift toward the pink area in a CIE 1976 UCS color coordinate system u′v′. In addition, when i) the carbon black or ii) the cyan wavelength-absorbing material and the orange wavelength-absorbing material are contained together with the green wavelength-absorbing material, the color coordinates shift toward the purplish pink area in the color coordinate system u′v′.

In the color coordinate system u′v′, it is preferred that the value of Δv′/Δu′, i.e. (v′₆₀−v′₀)/(u′₆₀−u′₀), exists in the range from tan(−15°) to tan(45°). (Here, u′₀, v′₀ are color coordinate values measured at a watching angle of 0°, and u′₆₀ and v′₆₀ are color coordinate values measured at a watching angle of 60°.)

Specifically, when only the green wavelength-absorbing material is contained in the color shift-reducing pattern 20, it is preferred that the slope of the change in color coordinates at a watching angle of 60° with respect to the front in the color coordinate system u′v′ exists in the range from 15° to 45°. When both the green wavelength-absorbing material and the carbon black are contained, it is preferred that the slope of the change in color coordinates at a watching angle of 60° with respect to the front exists in the range from −15° to 15°. In addition, when the green wavelength-absorbing material, the cyan wavelength-absorbing material, and the orange wavelength-absorbing material are contained, it is preferred that the slope of the change in color coordinates at a watching angle of 60° with respect to the front exists in the range from −15° to 15°.

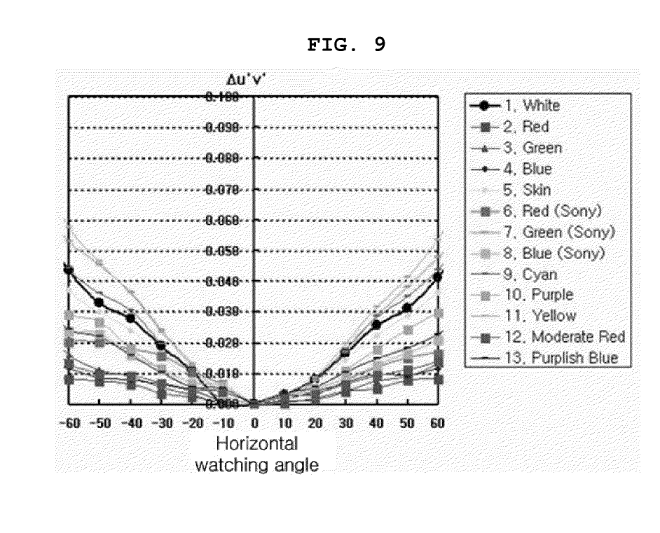

FIG. 9 is a graph showing color shifts of 13 colors in an LCD TV on which the optical filter shown in FIG. 6 is mounted.

The optical filter of FIG. 9 was fabricated by injecting 0.5 wt % green wavelength-absorbing material (e.g., pink colorant) into the color shift-reducing pattern 20 shown in FIG. 6.

### EMBODIMENTS OF THE INVENTION

FIG. 10 is a cross-sectional view showing an optical filter according to a first exemplary embodiment of the invention.

The optical filter of this embodiment is provided in front of a display panel of a display device.

The optical filter includes a background layer 10 and a color shift-reducing pattern.

The background layer 10 is in the form of a layer of a light-transparent material. The background layer 10 can be made of an Ultraviolet (UV) curing resin.

The color shift-reducing pattern is formed at the background layer 10 to have a predetermined thickness.

The color shift-reducing pattern can be one selected from among stripes having a wedge-shaped cross section, waves having a wedge-shaped cross section, a matrix having a wedge-shaped cross section, a honeycomb having a wedge-shaped cross section, stripes having a quadrangular cross section, waves having a quadrangular cross section, a matrix having a quadrangular cross section, or a honeycomb having a quadrangular cross section.

In addition, for example, the stripe pattern can be arranged in various ways, such as in horizontal stripes, in vertical stripes, or the like. A horizontal stripe pattern is effective in compensating for watching angles in the vertical direction, whereas a vertical pattern is effective in compensating for watching angles in the horizontal direction.

In addition, it is possible to effectively prevent a moiré phenomenon by arranging the pattern so that it has a predetermined bias angle with respect to the horizontal or vertical direction.

The color shift-reducing pattern can be formed such that the bottom surface thereof is oriented toward a viewer or toward the display panel. In addition, the color shift-reducing pattern can be formed on both surfaces of the background layer 1.

Although FIG. 10 shows the embodiment in which the color shift-reducing pattern is formed as an engraving with respect to the background layer 10, the present invention is not limited thereto. The color shift-reducing pattern can be formed as a embossing with respect to the background layer 10.

The color shift-reducing pattern includes a plurality of partial areas. Here, at least two partial areas have different light absorptivities and/or light diffusivities.

For this, the at least two partial areas can include different light-absorbing materials and/or light-diffusing materials. In an example, it is possible to provide different light absorptivities by injecting different types of light-absorbing materials into first and second partial areas 21 and 23.

In another example, the at least two partial areas can include different amounts of the light-absorbing materials and/or light-diffusing materials. These amounts may include an amount of 0.

Below, a more detailed description will be given. For example, in an embodiment including two partial areas, that is, the first and second partial areas 21 and 23, a variety of modifications can be made, in which i) the first partial area contains the light-absorbing material and the second partial area contains the light-diffusing material, as shown in FIG. 10, ii) the first partial area contains both the light-absorbing material and the light-diffusing material and the second partial area contains one of the light-absorbing material and the light-diffusing material, or iii) both the first and second partial areas contain both the light-absorbing material and the light-diffusing material.

Although partial areas can have a variety of arrangements, FIGS. 10, 17, and 18 show exemplary embodiments, in which the first partial area 21 is formed in front of or behind the second partial area 23.

The color shift-reducing pattern can contain i) a green wavelength-absorbing material, ii) a cyan wavelength-absorbing material and an orange wavelength-absorbing material together with a green wavelength-absorbing material, iii) a black material, such as carbon black, together with a green wavelength-absorbing material, a cyan wavelength-absorbing material, and an orange wavelength-absorbing material, iv) a black material, such as carbon black, together with a green wavelength-absorbing material, or v) a black material such as carbon black.

Color Shift-Reducing Pattern Containing Green Wavelength-Absorbing Material

In the display industry, a display device is typically evaluated by using 13 colors, namely, white, red, blue, green, skin, Sony red, Sony Blue, Sony green, cyan, purple, yellow, moderate red, and purplish blue.

When white light is emitted at a high gray level from a display panel, the luminance of light decreases over the entire wavelength range according to an increase in the watching angle, and particularly decreases most rapidly in the blue wavelength range. However, when light is emitted at a low gray level, the luminance of light increases over the entire wavelength range according to an increase in the watching angle, and particularly increases most rapidly in the green wavelength range.

Therefore, by the injection of the green wavelength-absorbing material into the color shift-reducing pattern, the absorption of light, which is emitted from the display panel, is caused to increase gradually over the entire wavelength range according to an increase in the watching angle, and the absorption of light in the green wavelength range from 510 nm to 560 nm is caused to increase in a relatively large amount. This serves to reduce the difference in a relative luminance of RGB due to the change in the watching angle and the gray level and thereby minimize the color shift according to increases in the watching angle.

The green wavelength-absorbing material can be one of inorganic and organic materials that can absorb green wavelength light in the range from 510 nm to 560 nm. It is preferred that pink colorant be used for the green wavelength-absorbing material. In addition to the pink colorant, examples of the green wavelength-absorbing material may include any materials that can absorb green wavelength light.

Color Shift-Reducing Pattern Containing Green Wavelength-Absorbing Material+Cyan Wavelength-Absorbing Material+Orange Wavelength-Absorbing Material

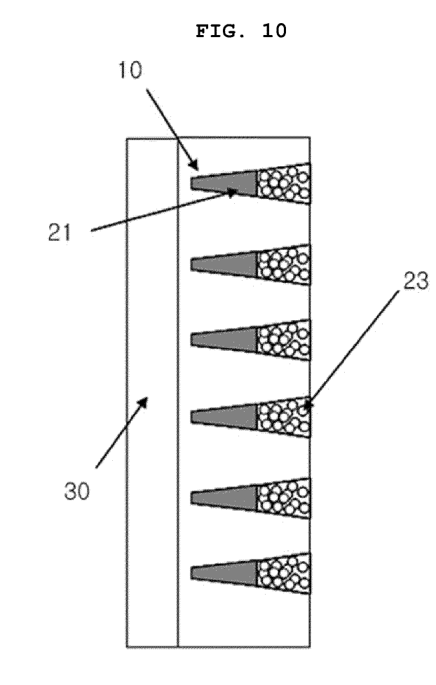

FIG. 11 is graphs showing the spectra of light emitted from Light-Emitting Diode (LED) and Cold Cathode Fluorescent Light (CCFL) backlights.

As shown in the figure, unlike the LED backlight (seen in the left part of FIG. 11), the CCFL backlight (seen in the right part of FIG. 11) exhibits strong peaks in the cyan wavelength range in the vicinity of 490 nm and in the orange wavelength range in the vicinity of 590 nm.

Such peaks in the cyan and orange wavelength ranges contribute to a reduction in the range of color reproduction and cause the color shift to deteriorate.

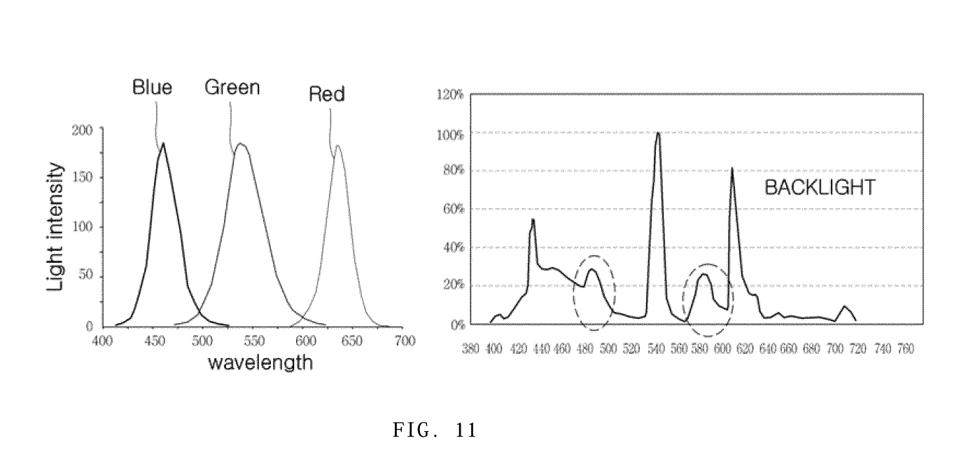

FIG. 12 is graphs showing color shifts depending on the watching angle for the LED and CCFL backlights.

As shown in the figure, referring to the color shift results of LCDs having the LED backlight (see in the left part of FIG. 12) and the CCFL backlight (seen in the right part of the FIG. 12), it can be appreciated that the result of the LCD having the CCFL backlight is inferior.

Accordingly, it is possible to further reduce the change in the color of the 13 colors according to an increase in the watching angle by ensuring that the peaks of the cyan wavelength range and the orange wavelength range, which would otherwise have a bad effect on color shift depending on the watching angle, are absorbed more according to an increase in the watching angle.

For this function, the color shift-reducing pattern can contain not only the green wavelength-absorbing material, which can absorb light having green wavelengths in the range from 510 nm to 560 nm, but also the cyan wavelength-absorbing material, which can absorb light having green wavelengths in the range from 480 nm to 510 nm, and the orange wavelength-absorbing material, which can absorb light having green wavelength in the range from 570 nm to 600 n.

As a result, when light is emitted from the display panel, the color shift-reducing pattern absorbs the green wavelength range more according to an increase in the watching angle. In addition, the color shift-reducing pattern absorbs more peaks in the cyan wavelength range and in the orange wavelength range, which have a bad effect on the color shift depending on the watching angle, from the LCD spectrum, according to an increase in the watching angle. This makes it possible to minimize the color changes according to an increase in the watching angle and minimize the changes in the color of all the 13 colors, including blue-shade colors and red-shade colors, thereby further increasing the viewing angle.

Color Shift-Reducing Pattern Containing Black Material

It is possible to mitigate the color shift by adding a black material, such as carbon black, into the color shift-reducing pattern.

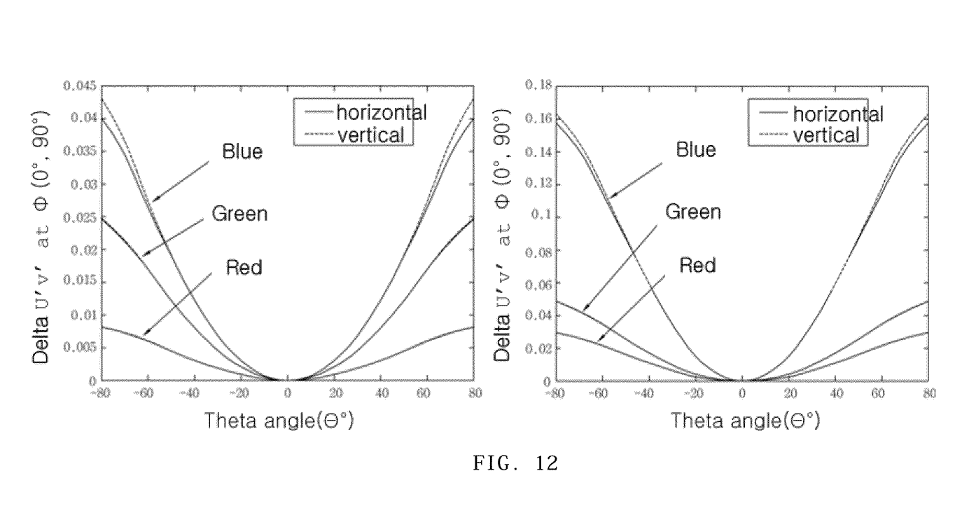

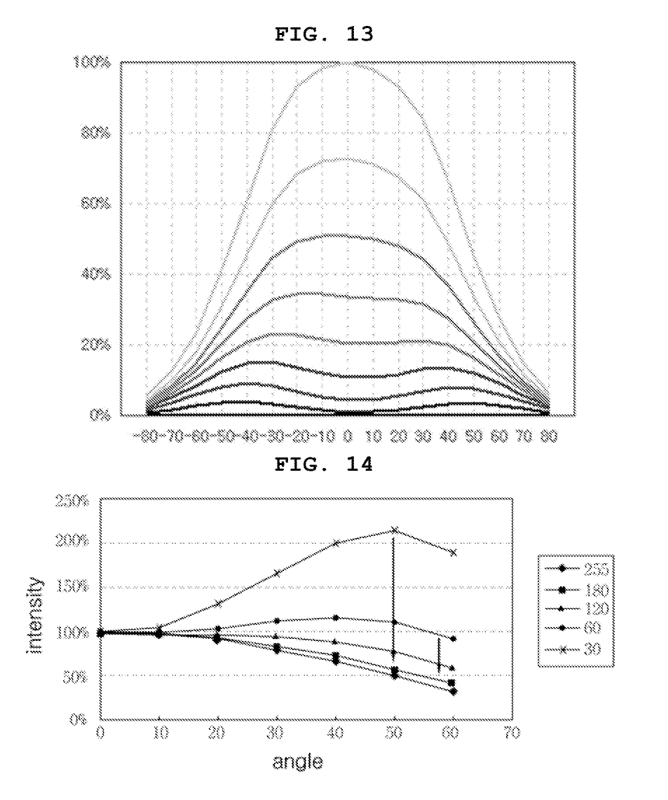

FIGS. 13 and 14 are reference views showing changes in luminance and normalized luminance depending on the watching angle and gray level in a bare LCD.

In a high gray level, the luminance decreases as the watching angle increases. However, as shown in FIGS. 13 and 14, in a low gray level, the increase in the luminance according to an increase in the watching angle causes the color shift to deteriorate. Therefore, it is possible to mitigate the color shift by ensuring that light emitted from the display panel is absorbed more according to an increase in the watching angle, so that luminance decreases according to an increase in the watching angle irrespective of the gray level.

It is preferred that the amount of carbon black be in the range from 0.05 wt % to 0.9 wt %.

The background layer 10 or a backing layer 30 can contain a color correction material that changes or controls color balance by reducing or adjusting the amounts of red (R), green (G), and blue (B) colors.

When light is emitted in the front direction through the optical filter for a display device, the color shift-reducing pattern may adversely causes the color of an image of the display to change. Therefore, it may be preferred that the background layer 10 or the backing layer 30 contains a color correction colorant that absorbs wavelength ranges other than the green wavelength range, the orange wavelength range, and the cyan wavelength range. For example, it is possible to correct the color of light emitted in the front direction to be similar to the original color by adding, to the background layer 10 or the backing layer 30, suitable amounts of a green-complementary wavelength-absorbing material such as a red wavelength-absorbing material and a blue wavelength-absorbing material. Since this can be implemented by simply adding the color correction material into the background layer 10 or the backing layer 30 without providing a separate layer or film, it is possible to simplify the structure and fabrication processes of the optical filter.

The color correction material can be added to an adhesion layer in addition to the background layer 10 or the backing layer 30. The color correction material can also be added to other functional films.

Since the light-diffusing material more uniformly diffuses light emitted from the display panel, it promotes color mixing, thereby mitigating color shift.

The light-diffusing material can be made of light-diffusing particles such as light-diffusing beads.

The light-absorbing material and the light-diffusing material are typically mixed into a transparent polymer resin when they are added to the color shift-reducing pattern. It is preferred that the refractive index of the light-diffusing particles be greater than that of the polymer resin. Excellent light-diffusing effect can be obtained when the refractive index is 0.01 or more. It is preferred that the light-diffusing particles be white particles having an average diameter of 0.1 μm or more so that they can diffuse light over all wavelengths. However, the present invention is not limited thereto.

The light-diffusing particles can have two or more sizes and refractive indices. It is possible to properly control optical characteristics based on the material, refractive index, size, and particle size distribution of the light-diffusing particles.

The light-diffusing particles can include one or more selected from among Polymethylmethacrylate (PMMA), vinyl chloride, acrylic resins, Polycarbonate (PC) based resins, Polyethylene Terephthalate (PET) based resins, Polyethylene (PE) based resins, Polystyrene (PS) based resins, Polypropylene (PP) based resins, Polyimide (PI) based resins, glass, and oxides such as silica TiO₂.

In addition, as shown in FIG. 10, the optical filter can include the backing layer 30, which supports the background layer 10.

It is preferred that the backing layer 30 be made of a transparent resin film that allows Ultraviolet (UV) rays to pass through. As the material of the backing layer 30, it is possible to use, for example, Polyethylene Terephthalate (PET), Polycarbonate (PC), Polyvinyl Chloride (PVC), or the like.

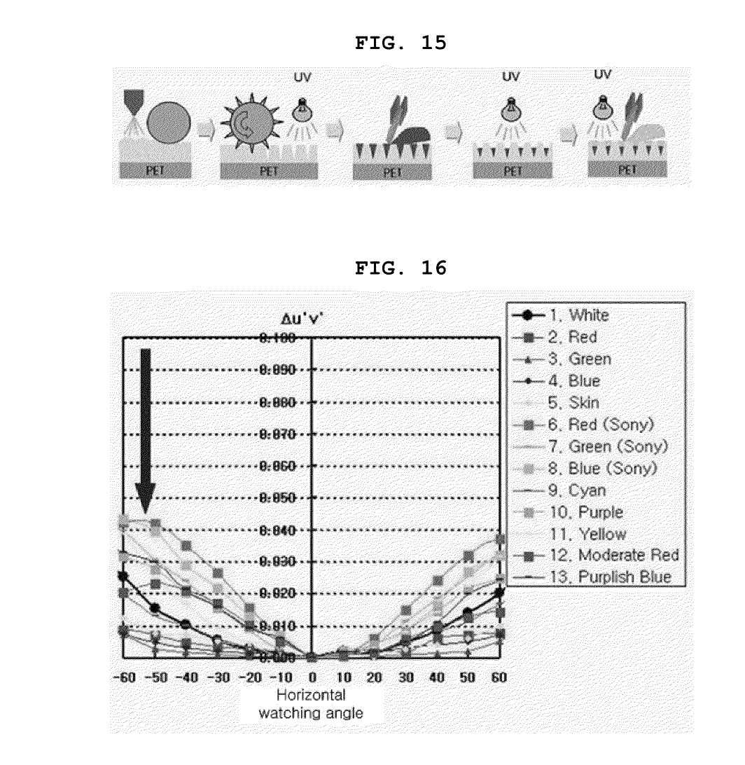

FIG. 15 is a flow diagram showing a process of fabricating the optical filter shown in FIG. 10.

A method of forming a color shift-reducing pattern includes the steps of applying a UV curing resin over one surface of the backing layer 30, and then engraving grooves on the UV curing resin using a pattern-forming roll. Afterwards, the UV curing resin is exposed to UV rays, thereby finally forming the background layer 10 in which the engraved grooves having a wedge-shaped cross section are formed.

In addition, a mixture including a light-absorbing material, a UV curing polymer resin, a solvent, etc. is injected into the engraved grooves, and then the solvent is vaporized by drying, so that the engraved grooves are filled about halfway. Afterwards, the mixture is cured by exposing it to UV rays.

Afterwards, another mixture including a light-diffusing material, a UV curing polymer resin, etc. is injected into the engraved grooves, followed by UV radiation, thereby completing the color shift-reducing pattern.

However, the present invention is not limited thereto. The engraved grooves of the background layer can be produced by using a variety of methods, such as a hot press method using a thermoplastic resin, an injection molding method in which a thermoplastic resin or a thermosetting resin is injected, and then is molded.

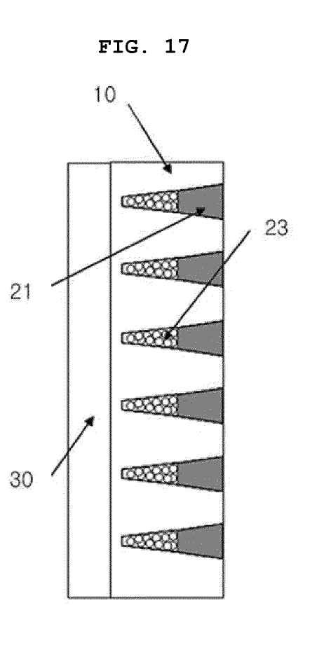

FIG. 16 is a graph showing color shifts in an LCD on which the optical filter shown in FIG. 10 is mounted.

The optical filter was fabricated by adding a green wavelength-absorbing material (pink colorant) of 0.5 wt % to the first partial area 21, light-diffusing beads of 1 wt % to the second partial area 23, in which the light-diffusing beads has a refractive index of 1.59 (the difference from that of the polymer resin is 0.09) and an average diameter of 6 μm. Thereby, the color shift result shown in FIG. 16 was obtained.

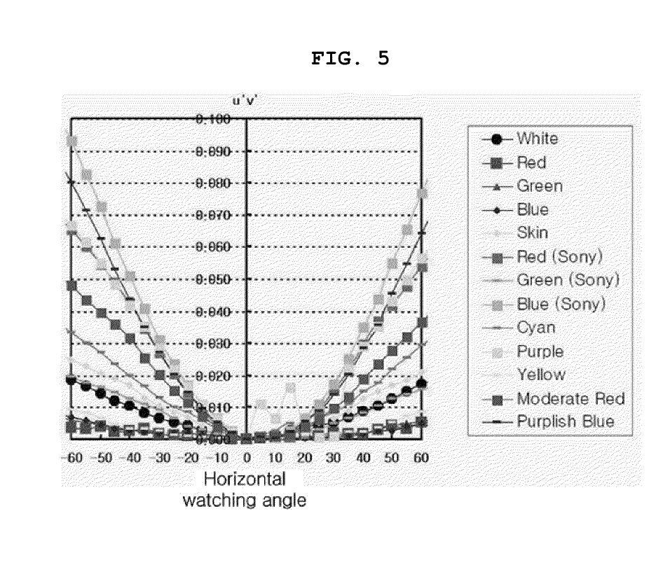

When compared with FIGS. 5 and 9, it can be appreciated that the effect of mitigating color shift is improved for all the 13 colors.

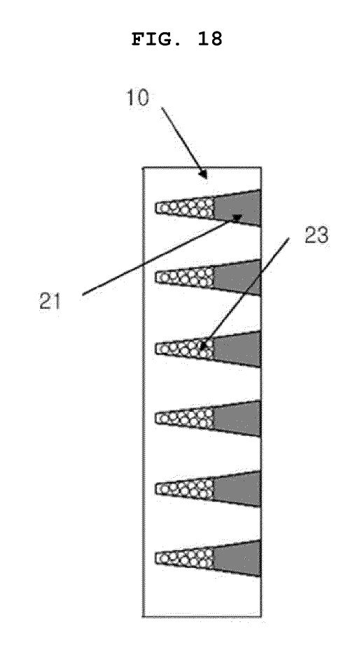

FIG. 17 is a cross-sectional view showing an optical filter according to a second exemplary embodiment of the invention, and FIG. 18 is a cross-sectional view showing an optical filter according to a third exemplary embodiment of the invention.

As shown in the figure, the arrangement of the first and second partial areas 21 and 23 can have a variety of modifications, and the backing layer 30 can be excluded in some embodiments.

The optical filter for a display device according to exemplary embodiments of the invention is disposed in front of the display panel, and can be formed by stacking a variety of functional films, such as an antireflection layer, an antiglare layer, an anti-fog layer, or the like, over a transparent substrate, in addition to the background layer and the backing layer.

Although only the LCD has been described, by way of example, as the display device of the invention, for the sake of convenience, the display device of the invention is not limited thereto. The display device of the invention can include a variety of devices, namely, a large size display device, which reproduces RGB colors, such as a Plasma Display Panel (PDP), an Organic Light-Emitting Diode (LED), a Field Emission Display (FED), or the like; a small mobile display device, such as a Personal Digital Assistant (PDA), a display window of a small size game machine, a display window of a mobile phone, or the like; a flexible display device; or the like.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An optical filter provided in front of a display panel of a display device, comprising:
a background layer; and
a color shift-reducing pattern formed to a predetermined thickness at the background layer,
wherein the color shift-reducing pattern has a plurality of partial areas,
wherein at least two partial areas of the plurality of partial areas have different light absorptivities and/or light diffusivities.

2. The optical filter according to claim 1, wherein the at least two partial areas contain different light-absorbing materials that cause the different light-absorptivities and/or different light-diffusing materials that cause the different light diffusivities.

3. The optical filter according to claim 1, wherein the at least two partial areas contain different amounts of a light-absorbing material that cause the different light-absorptivities and/or different amounts of a light-diffusing material that cause the different light diffusivities.

4. The optical filter according to claim 3, wherein the color shift-reducing pattern has first and second partial areas,
wherein only the first partial area contains the light-absorbing material, and only the second partial area contains the light-diffusing material.

5. The optical filter according to claim 4, wherein the first partial area is formed in front of or behind the second partial area.

6. The optical filter according to claim 3, wherein the color shift-reducing pattern has first and second partial areas,
wherein the first partial area contains both the light-absorbing material and the light-diffusing material, and the second partial area contains only one of the light-absorbing material and the light-diffusing material.

7. The optical filter according to claim 3, wherein the color shift-reducing pattern has first and second partial areas,
wherein the first and second partial areas contain both the light-absorbing material and the light-diffusing material.

8. The optical filter according to claim 3, wherein the light-absorbing material includes a green wavelength-absorbing material that absorbs light having green wavelengths from 510 nm to 560 nm.

9. The optical filter according to claim 8, wherein the light-absorbing material further includes a cyan wavelength-absorbing material that absorbs light having cyan wavelengths from 480 nm to 510 nm and an orange wavelength-absorbing material that absorbs light having orange wavelengths from 570 nm to 600 nm.

10. The optical filter according to claim 8, wherein the light-absorbing material further includes a black material.

11. The optical filter according to claim 3, wherein the light-absorbing material includes a black material.

12. The optical filter according to claim 11, wherein the black material is carbon black.

13. The optical filter according to claim 3, wherein the light-diffusing material includes light-diffusing beads.

14. The optical filter according to claim 1, wherein the color shift-reducing pattern includes a polymer resin.

15. The optical filter according to claim 1, wherein the color shift-reducing pattern is one selected from the group consisting of stripes having a wedge-shaped cross section, waves having a wedge-shaped cross section, a matrix having a wedge-shaped cross section, a honeycomb having a wedge-shaped cross section, stripes having a quadrangular cross section, waves having a quadrangular cross section, a matrix having a quadrangular cross section, and a honeycomb having a quadrangular cross section.

16. A display device comprising the optical filter set forth in claim 1.

17. A method of fabricating an optical filter having a color shift-reducing pattern, the optical filter provided in front of a display panel of a display device, the method comprising the steps of:
preparing a background layer having grooves thereon;
injecting a material forming a first partial area of the color shift-reducing pattern together with a solvent into the grooves;
vaporizing the solvent; and
injecting a material forming a second partial area of the color shift-reducing pattern into the grooves.
